(19) United States
(12) Patent Application Publication
(10) Pub. No.: US 2007/0077077 A1
(43) Pub. Date: Apr. 5, 2007

(54) Fixing device and image forming apparatus and temperature controlling method thereof

(75) Inventors: Jae-Hyeuk Jeong, Suwon-si (KR); Kyung-Shig Chung, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/442,311

(22) Filed: May 30, 2006

(30) Foreign Application Priority Data
Sep. 30, 2005 (KR) 2005-92180

(51) Int. Cl. G03G 15/20

(52) U.S. Cl. 399/33

(57) ABSTRACT

A fixing device and image forming apparatus, and a method thereof are provided. The fixing device and image forming apparatus include a heat roller heated by a heat source; a pressure roller disposed opposite to the heat roller; a temperature cutoff device spaced apart from the heat roller to cut the power supply of the heat source when the temperature of the heat roller is higher than a predetermined temperature; and a contact member that causes the heat roller and the temperature cutoff device to come in contact with each other so that the heat of the heat roller is transmitted to the temperature cutoff device.

### CROSS-REFERENCE TO RELATED APPLICATION

This application claims the benefit under 35 U.S.C. §119(a) of a Korean Patent Application, Serial No. 10-2005-0092180, filed on Sep. 30, 2005 in the Korean Intellectual Property Office, the entire contents of which is hereby incorporated by reference.

### BACKGROUND OF THE INVENTION

1. Field of the Invention

The present invention relates to a fixing device and an image forming apparatus including the same and temperature controlling method thereof. More particularly, the present invention relates to a method and a fixing device capable of preventing overheating and an image forming apparatus including the same.

2. Description of the Related Art

Electro-photographic image forming apparatuses are widely used in laser printers, photocopiers, and facsimiles, among others. A conventional electro-photographic image forming apparatus scans laser light to form an electrostatic latent image on a photoconductor. Toner is developed on the photoconductor on which the electrostatic latent image is formed, and the toner image is transferred onto a printing medium. Heat and pressure are then applied to the printing medium, on which the toner image is formed, to fix the toner image, thereby forming an image.

The fixing device includes a heat roller and a pressure roller. The heat roller is heated by radiant heat which is transmitted from a heat source such as a halogen lamp. The pressure roller is disposed opposite to the heat roller to apply pressure on the heat roller, thereby forming a fixing nip. While a printing medium passes through the fixing nip, a toner image is fixed on the printing medium by the heat and pressure generated from the heat roller and the pressure roller.

If the heat source cannot be controlled due to a malfunction of a control circuit or the like, the heat roller will overheat. For example, when the heat source is not turned off, the temperature of the heat roller will continuously increase, because the heat roller maintains a proper fixing temperature by turning the heat source on and off. In order to prevent overheating of the heat roller, a temperature cutoff device is provided around the heat roller to detect the temperature of the heat roller and cut the power supply of the heat source. Generally, a thermostat is used as the temperature cutoff device. The thermostat detects the temperature around the heat roller through a bimetal to cut the power supply of the heat source when the temperature is more than a predetermined temperature.

In order to prevent overheating of the heat roller, the temperature cutoff device must precisely detect the temperature of the heat roller and quickly cut the power supply when overheating is detected.

Japanese Unexamined Patent Application Publication No. 11-237805, which is expressly incorporated by reference herein, discloses a fixing device having a ring-shaped flange member provided on a thermostat body. Radiant heat generated from a heat roller is absorbed through the flange member to thereby increase heat response of the thermostat.

Japanese Unexamined Patent Application Publication No. 5-2355, which is expressly incorporated by reference herein, discloses a fixing device which causes a thermostat to contact a heat roller when the heat roller stops and which separates the thermostat from the heat roller when the heat roller rotates.

In general, a temperature cutoff device does not contact a heat roller. The temperature cutoff device is separated from the heat roller because a surface layer formed on the heat roller, such as, an elastic layer or release layer can be damaged, when the temperature cutoff device and heat roller directly contact each other.

In the case where the temperature cutoff device is separated from the heat roller, heat response and heat sensitivity of the temperature cutoff device are decreased because it detects the surrounding heat through the air to be operated. For example, there is a difference between an actual temperature of the heat roller and a temperature to be measured by the temperature cutoff device. This difference exists because the temperature cutoff device estimates the temperature of the heat roller through the surrounding air. Also, a constant delay time is consumed until the temperature cutoff device operates after the temperature of the heat roller exceeds a predetermined overheating temperature. When the heat roller is overheated during the delay time so that the temperature excessively increases, the heat roller can be broken or a peripheral portion of the heat roller can be deformed.

Accordingly, there is a need for an improved system for providing a fixing device and an image forming apparatus including same capable of instantly preventing overheating of a heat roller.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a fixing device and method where a heat roller is prevented from overheating.

An exemplary embodiment of the present invention also provides an image forming device including a fixing device capable of preventing a heat roller from overheating.

According to an aspect of an exemplary embodiment of the present invention, a fixing device includes a heat roller, a pressure roller, a temperature cutoff device, and a contact member. The heat roller is heated by a heat source. The pressure roller is disposed opposite to the heat roller. The temperature cutoff device is spaced apart from the heat roller to cut the power supply of the heat source when the temperature of the heat roller is higher: than a predetermined temperature. The contact member contacts the heat roller and the temperature cutoff device to transmit the heat of the heat roller to the temperature cutoff device.

The heat roller may include a roller body, in which the heat source is disposed, and a surface layer formed on the circumference of the roller body. The contact member may contact the roller body or the edge of the roller body, on which the surface layer is not formed. Alternatively, the contact member may contact the inner surface of the roller body.

According to another aspect of an exemplary embodiment of the present invention, a fixing device includes a heat roller, a pressure roller, temperature cutoff device, and a contact member. The heat roller is heated by a heat source disposed therein. The pressure roller is disposed opposite to the heat roller. The temperature cutoff device is spaced apart from the heat roller to cut the power supply of the heat source when the temperature of the heat roller is higher than a predetermined temperature. One end of the contact member is inserted into the heat roller and the other end contacts the temperature cutoff device to transmit the heat of the heat roller to the temperature cutoff device.

At least one of both sides of the heat roller may be opened, and one end of the contact member may be inserted into the opened side of the heat roller. Alternatively, a circular groove may be formed in a side surface of the heat roller about an axis of the heat roller, and the one end of the contact member may be inserted into the heat roller through the groove. In this case, the one end of the contact member may be positioned between an inner surface of the heat roller and the heat source. Alternatively, the one end of the contact member may contact the inner surface of the heat roller.

According to still another aspect of an exemplary embodiment of the present invention, an image forming apparatus includes an image forming section and a fixing device. The image forming section transfers a toner image onto a printer medium through an electrostatic latent image formed on a photo conductor and a fixing device fixes the toner image. The fixing device includes a heat roller, a pressure roller, a temperature cutoff device, and a contact member. The heat roller is heated by a heat source. The pressure roller is disposed opposite to the heat roller. The temperature cutoff device is spaced apart from the heat roller to cut the power supply of the heat source when the temperature of the heat roller is higher than a predetermined temperature. The contact member causes the heat roller and temperature cutoff device to contact each other so that the heat of the heat roller is transmitted to the temperature cutoff device.

According to yet another aspect of an exemplary embodiment of the present invention, an image forming apparatus includes an image forming section and a fixing device. The image forming section transfers a toner image onto a printer medium through an electrostatic latent image formed on a photo conductor and the fixing device fixes the toner image. The fixing device includes a heat roller, a pressure roller, a temperature cutoff device, and a contact member. The heat roller is heated by a heat source disposed therein and the pressure roller is disposed opposite to the heat roller. The temperature cutoff device is spaced apart from the heat roller to cut the power supply of the heat source when the temperature of the heat roller is higher than a predetermined temperature. One end of the contact member is inserted into the heat roller and the other end contacts the temperature cutoff device to transmit the heat of the heat roller to the temperature cutoff device.

According to another aspect of an exemplary embodiment of the present invention a temperature controlling method is provided, the method including the steps of cutting a power supply of a heat source in at least one of a fixing device and an image forming apparatus, when a temperature of a heat roller is higher than a referenced temperature; and contacting a heat roller and a temperature cutoff device to transmit heat of the heat roller to a temperature cutoff device.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 is a schematic view illustrating the inner construction of an image forming apparatus according to an exemplary embodiment of the present invention;

FIG. 2 is an exploded perspective view of a fixing device of FIG. 1;

FIG. 3 is a horizontal cross-sectional view of the fixing device of FIG. 1;

FIG. 4 is a horizontal cross-sectional view of a fixing device according to another exemplary embodiment of the present invention;

FIG. 5 is a horizontal cross-sectional view of a fixing device according to still another exemplary embodiment of the present invention;

FIG. 6 is a perspective view of a fixing device according to yet another exemplary embodiment of the present invention; and

FIG. 7 is a horizontal cross-sectional view of a fixing device according to yet another exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

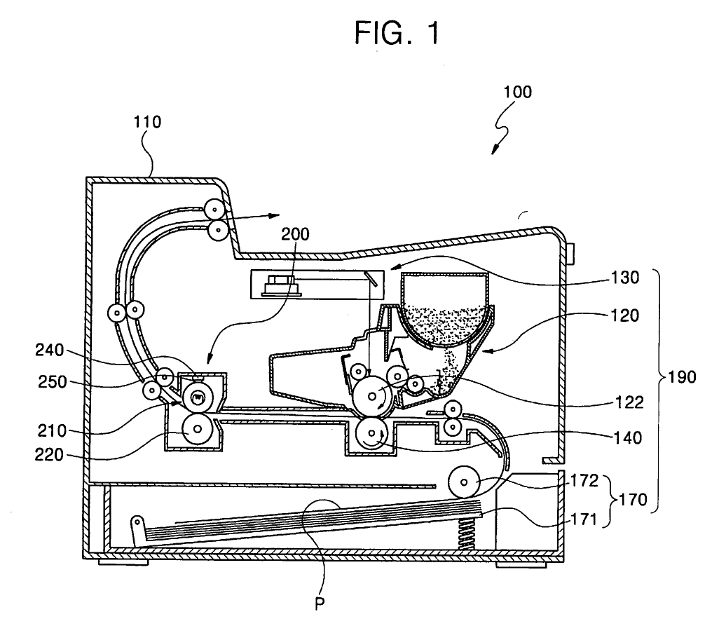

FIG. 1 is a schematic view illustrating the inner construction of an image forming apparatus according to an exemplary embodiment of the present invention.

Referring to FIG. 1, the image forming apparatus 100 includes a main body 110, an image forming section 190, and a fixing device 200, which are provided in the main body 110. The image forming section 190 includes a paper feed unit 170, a developing unit 120, a light scanning unit 130, and a transfer unit 140.

The paper feed unit 170 is provided in the lower portion of the main body 110 to feed a printing medium P to the developing unit 120. The paper feed unit 170 includes a paper feed cassette 171 and a pickup roller 172. The printing medium P is loaded on the paper feed cassette and a pickup roller 172 picks up one printing medium P at a time on which an image is formed.

The light scanning unit 130 forms an electrostatic latent image on a photo-conductor 122 of the developing unit 120 using laser light. The developing unit 120 develops a toner image on the photo-conductor 122 with the electrostatic latent image formed thereon. The transfer unit 140 transfers the toner image onto the printing medium P.

The fixing device 200 applies heat and pressure to the transferred toner image to fix the image on the printing medium P. The printing medium P on which the image has been completely fixed is then discharged to the outside of the main body 110.

The image forming section 190 configured as described above is well known to those skilled in the art, so its detailed description will be omitted. In the following exemplary embodiment of the present invention, a black-and-white image forming apparatus will be exemplified. Exemplary embodiments of the present invention can be applied to a color image forming apparatus.

The fixing device 200 includes a heat roller 210, a pressure roller 220, a temperature cutoff device 240, and a contact member 250.

The heat roller 210 is heated by a heat source 215 disposed therein. The pressure roller 220 opposite to the heat roller 210 applies pressure on the heat roller 210 to form a nip. In order to apply pressure to the heat roller 210, a pressure mechanism (not shown) is provided in the pressure roller 220.

At least one of the heat roller 210 and the pressure roller 220 is driven by a driving mechanism (not shown). While the printing medium P passes through the fixing nip, the toner image is fixed on the printing medium P by the heat of the heat roller 210 and the pressure of the pressure roller 220.

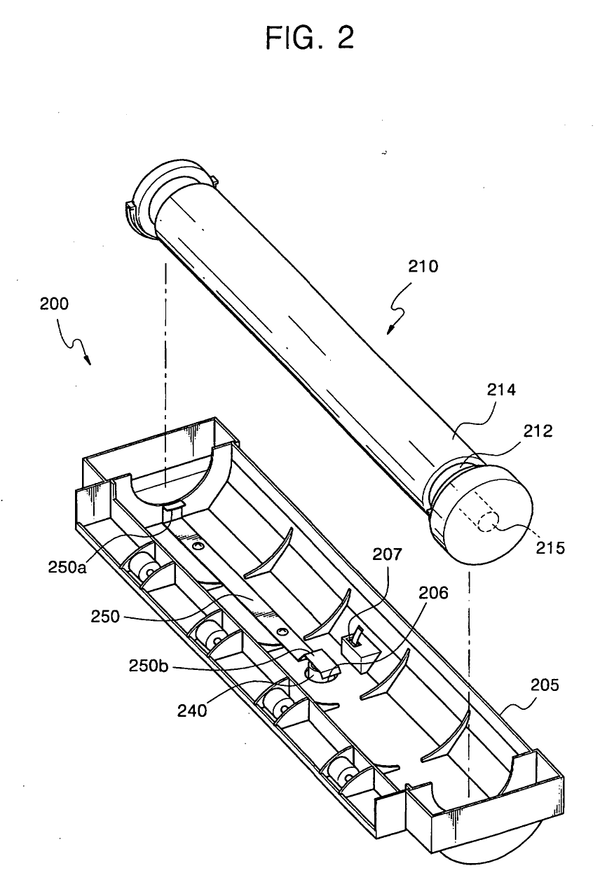

FIG. 2 is an exploded perspective view of the fixing device of FIG. 1. The pressure roller 220, is not shown for clarity.

Referring to FIG. 2, the heat roller 210, the temperature cutoff device 240, and the contact member 250 are disposed in a housing 205 of the fixing device 200. In the housing 205, a temperature sensor 207, such as a thermostat, for detecting the temperature of the heat roller 210 can be further provided. While the temperature of the heat roller 210 is detected through the temperature sensor 207, a control section (not shown) of the image forming apparatus 100 controls the temperature of the heat roller 210 by turning the heat source 215 on and off.

The heat roller 210 includes a heat source 215, a roller body 212 made of metal on which the heat source 215 is provided, and a surface layer 214 formed on the circumference of the roller body 212.

The heat source 215 may be one of various types of heating elements, such as a halogen lamp, a heating coil, and an inductive heating coil, which receive electric power to increase the temperature of the heat roller 210.

The roller body 212 is directly heated by the heat source 215. In general, the roller body 212 is a hollow cylindrical pipe, which is formed of metal such as aluminum or stainless steel.

The roller body 212 is rotatably supported by the housing 205. The housing 205, which is a portion of the main body 110 of the image forming apparatus 100, is formed to extend in an axial direction of the heat roller 210.

The surface layer 214 is formed on the circumference of the roller body 212. The surface layer 214 may be a release layer made of a fluoride resin. The surface layer 214 may also include an elastic layer formed on the circumference of the roller body 212, and a release layer formed on the elastic layer. The elastic layer may be formed of silicon rubber, urethane, and resin foam, among others.

The surface layer 214 is formed on a portion of the circumference of the roller body 212, other than the entire circumference. The portion of the roller body 212 is exposed outside. For example, the surface layer 214 has a width corresponding to the maximum width of the printing medium P to be fixed, and the width of the roller body 212 is larger than a width where the surface layer 214 is formed, so that at least one of both edges of the roller body 212 is exposed outside.

The temperature cutoff device 240 is spaced apart from the heat roller 210 to determine whether the heat roller 210 is overheated. When the temperature of the heat roller 210 is higher than a predetermined temperature, the temperature cutoff device 240 forcibly cuts the power supply of the heat source 215, thereby preventing overheating of the heat roller 210. The temperature cutoff device 240 is fixed to be inserted from the outside of the housing 205 through a through-hole 206 formed on the housing 205.

The temperature cutoff device 240 may employ a thermostat. A thermostat, which is generally formed in a disc shape, has a bimetal for detecting a temperature. The thermostat is spaced apart from the heat roller 210 by a predetermined distance and the bimetal is opposite to the heat roller 210. When the thermostat detects a temperature higher than a predetermined temperature, a bimetal engagement is released to short a circuit connected to the heat source 215.

The temperature cutoff device 240 may be another member, which forcibly shorts a circuit according to a predetermined temperature. The temperature cutoff device 240 is not limited to the thermostat and other mechanisms, such as a temperature fuse, can be used.

The contact member 250 is disposed in the housing 205 to increase heat response and heat sensitivity of the temperature cutoff device 240. The contact member 250 causes the heat roller 210 and the temperature cutoff device 240 to contact each other so that the heat of the heat roller 210 is directly transmitted to the temperature cutoff device 240.

The contact member 250 may be formed of a metal material having high thermal conductivity, such as copper or aluminum. Also, the contact member 250 can be insulation-coated to prevent short-circuit with another member for electric wiring.

The contact member 250 can be fixed to the housing 205 by a fastening member such as a screw, or fixed by an adhesive or the like. FIG. 2 shows a state where the contact member 250 is attached and fixed on the inner surface of the housing 205. While the contact member 250 closely contacts an inner surface of the housing 205, the contact member 250, excluding a sensing section 250a and contact section 250b to be described below, can be disposed outside the housing 205 to be securely fixed to the outer surface of the housing 205.

The contact member 250 includes the sensing section 250a which contacts the heat roller 210, and the contact section 250b which contacts the temperature cutoff device 240.

The sensing section 250a of the contact member 250 contacts the heat roller 210. Preferably, the sensing section 250a contacts the roller body 212 of the heat roller 210. For this, the sensing section 250a contacts the edge where the surface layer 214 is not formed in the circumference of the roller body 212.

If the contact member 250 directly contacts the surface layer 214 of the heat roller 210, the surface layer having a relatively low strength may be damaged. Also, the surface layer 214, to which a heat is transmitted from the heated roller body 212, has heat response lower than that of the metallic roller body 212. Therefore, the contact member 250 does not contact the surface layer 214, but directly contacts the roller body 212.

The sensing section 250a is bent along the circumference of the roller body 212 to expand a contact area with the roller body 212. Further, the sensing section 250a contacts the surface of the roller body 212, thereby improving thermal conductivity.

The contact section 250b of the contact member 250 contacts the temperature cutoff device 240. The contact section 250b is formed to cover the whole surface of a portion where the temperature of the temperature cutoff -device 240 is detected, thereby improving thermal conductivity.

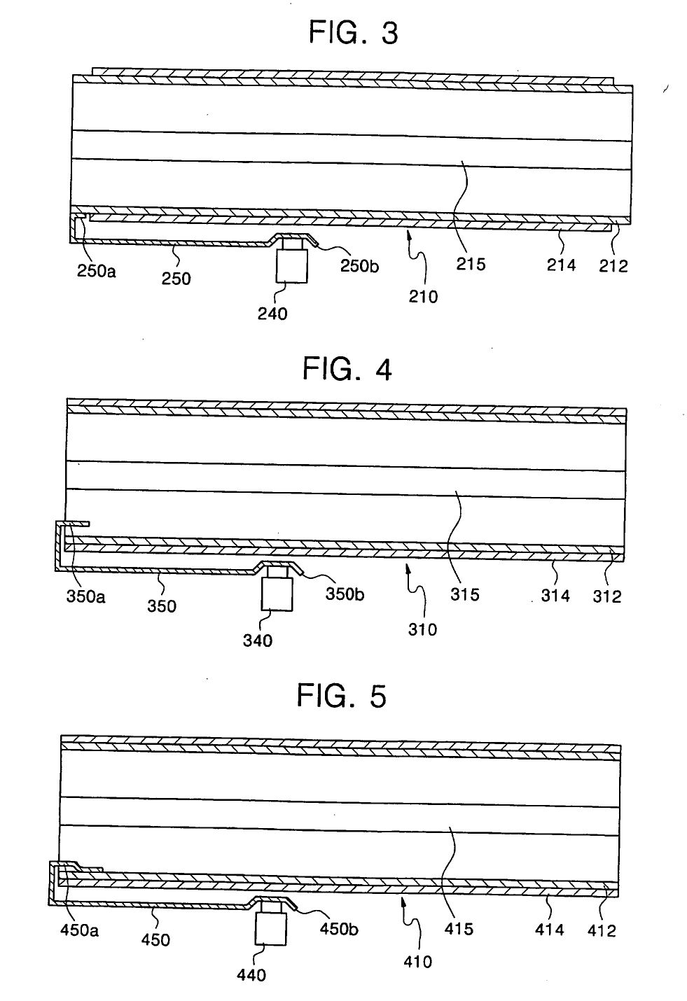

FIG. 3 is a horizontal cross-sectional view of the fixing device of FIG. 1.

Referring to FIG. 3, the edge of the roller body 212 in the heat roller 210 is exposed, so the sensing section 250a of the contact member 250 contacts the exposed edge of the roller body 212. The contact member 250 extends in an L-shape along the housing 205 in the longitudinal direction of the heat roller 210, so the contact section 250b contacts the temperature cutoff device 240.

The heat of the heat roller 210 is directly transmitted to the temperature cutoff device 240 through the contact member 250 having high thermal conductivity. This allows heat response and heat sensitivity of the temperature cutoff device 240 to be increased. Therefore, the temperature cutoff device 240 can operate more precisely and quickly.

Also, there is no requirement that the temperature cutoff device 240 and the heat roller 210 should be disposed adjacent to each other to increase heat response. Since heat is transmitted to the temperature cutoff device 240 through the contact member 250, design constraint in setting the position of the temperature cutoff device 240 can be removed.

Hereinafter, operation of the image forming apparatus constructed in such a manner according to an exemplary embodiment of the present invention will be described.

The paper feed unit 170 of the image forming section 190 picks up the printing medium P from the paper feed cassette 171 to guide the printing medium P toward the developing unit 120. The developing unit 120 develops toner on the photo conductor 122 on which an electrostatic latent image is formed, and the toner image is transferred onto the printing medium P through the transfer unit 140.

In the fixing device 200, the heat roller 210 maintains a predetermined fixing temperature using the heat source 215. The printing medium P on which the toner image is formed is fixed while passing through the fixing nip of the fixing device 200.

Malfunctions in a control circuit of the heat source 215 and the like can cause the heat roller 210 to overheat. Since the heat of the heat roller 210 is directly transmitted to the heat shielding member 240 through the contact member 250, overheating of the heat roller 210 can be quickly detected. When overheating of the heat roller 210 is detected, the temperature cutoff device 240 forcibly cuts the power supply of the heat source 215.

FIG. 4 is a horizontal cross-sectional view of a fixing device according to another exemplary embodiment of the present invention.

Referring to FIG. 4, a roller body 312 of a heat roller 310 is a hollow metal pipe, and a heat source 315 is provided in the roller body 312.

At least one of both sides of the roller body 312 can be opened. In this case, a sensing section 350a of a contact member 350 is inserted into the opened side of the roller body 312. As a result, the sensing section 350a is positioned between the inner surface of the roller body 312 and the heat source 315.

The sensing section 350a is inserted into the roller body 312, so the heat to be generated from the heat source 315 is transmitted to a temperature cutoff device 340 through the contact section 350b.

FIG. 5 is a horizontal cross-sectional view of a fixing device according to still another exemplary embodiment of the present invention.

Referring to FIG. 5, a sensing section 450a of a contact member 450 is inserted through the side, which is opened into a roller body 412 of a heat roller 410. The sensing section 450a directly contacts the inner surface of the roller body 412 to detect the temperature of the roller body 412. Other components are analogous to those of the exemplary embodiments of the present invention as shown in FIG. 4, so their descriptions will be omitted for clarity and conciseness.

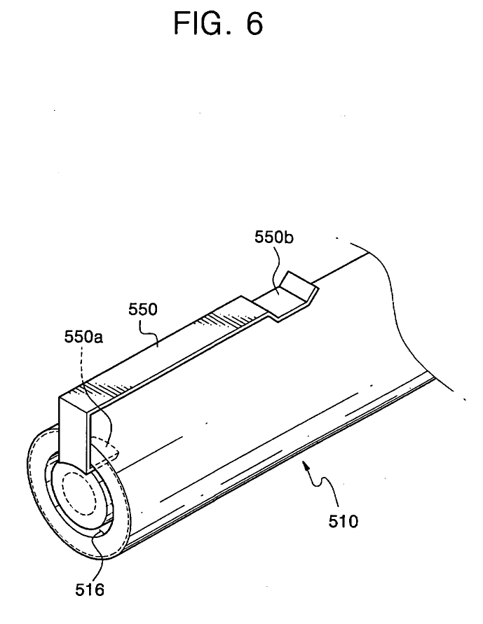

FIG. 6 is a perspective view of a fixing device according to yet another exemplary embodiment of the present invention.

Referring to FIG. 6, a sensing section 550a of a contact member 550 is inserted into a heat roller 510 through a groove 516 formed in the side of the heat roller 510. The groove 516 is formed in a circular shape, centered on the axis of the heat roller 510, so that the contact member 550 inserted into the groove 516 will not be caught even though the heat roller 510 rotates.

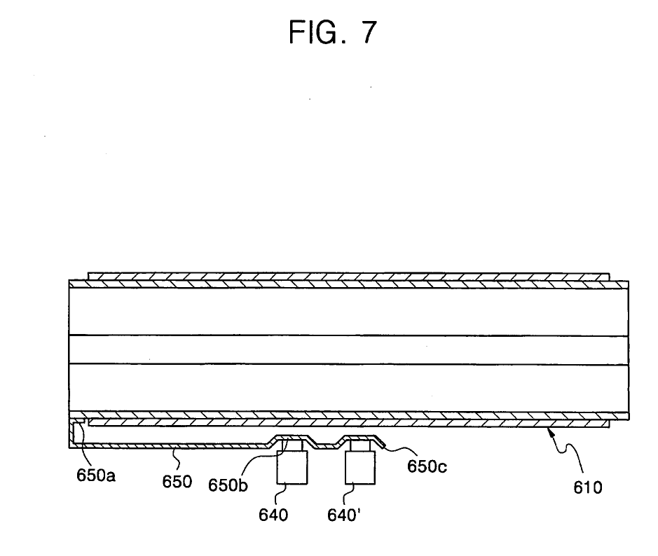

FIG. 7 is a horizontal cross-sectional view of a fixing device according to yet another exemplary embodiment of the present invention.

Referring to FIG. 7, two temperature cutoff devices 640 and 640′ are disposed. A sensing section 650a of a contact section 650 contacts a heat roller 610. A first contact section 650b and a second contact section 650c are formed to extend in line up to the positions of the temperature cutoff devices 640 and 640′. The first contact section 650b and the second contact section 650c contact the first temperature cutoff device 640 and the second temperature cutoff device 640′, respectively. For example, the two contact sections 650b and 650c connected in line to each other contact the two temperature cutoff devices 640 and 640′, respectively. This permits the heat of the heat roller 610 to be transmitted to the two temperature cutoff devices 640 and 640′.

A plurality of temperature cutoff devices, other than a single temperature cutoff device, can be disposed. This is a result of a plurality of temperature cutoff devices having different temperature settings or different heat responses used to determine in several steps whether overheating occurs. In this case, the contact sections of the contact member can be formed to correspond to the respective temperature cutoff devices.

According to an exemplary embodiment of the present invention as described above, the heat of the heat roller is directly transmitted to the temperature cutoff device through the contact member having high thermal conductivity, so that heat response and heat sensitivity of the temperature cutoff device can be increased. Therefore, the temperature cutoff device can operate more precisely and quickly, thereby enhancing the reliability of the fixing device and image forming apparatus.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A fixing device comprising:
a heat roller heated by a heat source;
a pressure roller disposed opposite to the heat roller;
a temperature cutoff device for cutting a power supply of the heat source when a temperature of the heat roller is higher than a referenced temperature, wherein the temperature cutoff device is spaced apart from the heat roller; and
a contact member for contacting the heat roller and the temperature cutoff device to transmit the heat of the heat roller to the temperature cutoff device.

2. The fixing device according to claim 1, wherein the heat roller comprises a roller body in which the heat source is disposed and a surface layer formed on a circumference of the roller body.

3. The fixing device according to claim 2, wherein the contact member is in contact with the roller body.

4. The fixing device according to claim 2, wherein the contact member is in contact with an edge of the roller body, on which the surface layer is not formed.

5. The fixing device according to claim 2, wherein the contact member is in contact with an inner surface of the roller body.

6. The fixing device according to claim 1, wherein at least one of both sides of the heat roller is opened and the contact member is inserted into an opened side of the heat roller.

7. A fixing device comprising:
a heat roller heated by a heat source disposed therein;
a pressure roller disposed opposite to the heat roller;
a temperature cutoff device for cutting a power supply of the heat source when a temperature of the heat roller is higher than a referenced temperature, wherein the temperature cutoff device is spaced apart from the heat roller; and
a contact member of which one end is inserted into the heat roller and the other end is in contact with the temperature cutoff device to transmit heat of the heat roller to the temperature cutoff device.

8. The fixing device according to claim 7, wherein at least one of both sides of the heat roller is opened and the one end of the contact member is inserted into an opened side of the heat roller.

9. The fixing device according to claim 7, wherein a circular groove is formed about an axis of the heat roller in the side of the heat roller, and the one end of the contact member is inserted into the heat roller through the circular groove.

10. The fixing device according to claim 7, wherein the one end of the contact member is positioned between an inner surface of the heat roller and the heat source.

11. The fixing device according to claim 7, wherein the one end of the contact member is in contact with an inner surface of the heat roller.

12. An image forming apparatus comprising:
an image forming section for transferring a toner image onto a printer medium through an electrostatic latent image formed on a photo conductor; and
a fixing device for fixing the toner image, the fixing device comprising:
a heat roller heated by a heat source;
a pressure roller disposed opposite to the heat roller;
a temperature cutoff device for cutting a power supply of the heat source when a temperature of the heat roller is higher than a referenced temperature, wherein said temperature cutoff device is spaced apart from the heat roller; and
a contact member for causing the heat roller and temperature cutoff device to come in contact with each other whereby the heat of the heat roller is transmitted to the temperature cutoff device.

13. The image forming apparatus according to claim 12, wherein the heat roller comprises a roller body in which the heat source is disposed and a surface layer formed on a circumference of the roller body.

14. The image forming apparatus according to claim 13, wherein the contact member is in contact with the roller body.

15. The image forming apparatus according to claim 13, wherein the contact member contacts an edge of the roller body, on which the surface layer is not formed.

16. An image forming apparatus comprising:
an image forming section for transferring a toner image onto a printer medium through an electrostatic latent image formed on a photo conductor; and
a fixing device for fixing the toner image, the fixing device comprising:
a heat roller heated by a heat source disposed therein;
a pressure roller disposed opposite to the heat roller;
a temperature cutoff device for cutting a power supply of the heat source when a temperature of the heat roller is higher than a referenced temperature, wherein said temperature cutoff device is spaced apart from the heat roller; and
a contact member of which one end is inserted into the heat roller and the other end contacts the temperature cutoff device to transmit heat of the heat roller to the temperature cutoff device.

17. The image forming apparatus according to claim 16, wherein at least one of both sides of the heat roller is opened and the contact member is inserted into an opened side of the heat roller.

18. The image forming apparatus according to claim 16, wherein a circular groove is formed about an axis of the heat roller in a side of the heat roller, and the one end of the contact member is inserted into the heat roller through the circular groove.

19. The image forming apparatus according to claim 16, wherein the one end of the contact member is positioned between an inner surface of the heat roller and the heat source.

20. The image forming apparatus according to claim 16, wherein the one end of the contact member contacts an inner surface of the heat roller.

21. A temperature controlling method comprising:
cutting a power supply of a heat source in at least one of a fixing device and an image forming apparatus, when a temperature of a heat roller is higher than a referenced temperature; and
contacting a heat roller and a temperature cutoff device to transmit heat of the heat roller to the temperature cutoff device.

22. The temperature controlling method of claim 21, wherein the contacting comprises:
inserting one end of a contact member into the heat roller and contacting another end of the contact member with the temperature cutoff device.
